(19) United States
(12) Patent Application Publication
(10) Pub. No.: US 2012/0296716 A1
(43) Pub. Date: Nov. 22, 2012

(54) Management of an Offer for a Financial Incentive

(76) Inventors: Pierre C. Barbeau, Leawood, KS (US); James D. Barnes, Overland Park, KS (US); Mary Cole, Olathe, KS (US); Jeremy D. Lyman, Overland Park, KS (US)

(21) Appl. No.: 13/523,779

(22) Filed: Jun. 14, 2012

Related U.S. Application Data
(63) Continuation-in-part of application No. 13/111,185, filed on May 19, 2011.

(51) Int. Cl. G06Q 30/00

(52) U.S. Cl. 705/14.13; 705/14.1; 705/14.26

(57) ABSTRACT

A way of providing offers for financial incentives to users as part of an electronic customer loyalty, rewards, or discount program involving one or more merchants is provided. For example, an offer criterion is received from a merchant. The offer criterion is established by the merchant for each user and associated with one or more products or services offered by the merchant. First data indicative of at least partial satisfaction of the offer criterion by a user is received. It is determined whether the first data has caused the user to satisfy the offer criterion for that user. Upon determining that the first data has caused the user to satisfy the offer criterion for that user, second data is provided to a mobile device associated with the user. The second data is representative of an offer for a financial incentive redeemable with the merchant.

### REFERENCE TO RELATED APPLICATIONS

This application is a continuation-in-part application of “Management of an Offer for a Financial Incentive,” U.S. patent application Ser. No. 13/111,185, which was filed on May 19, 2011 and is hereby incorporated by reference in its entirety.

### BACKGROUND

Coupons, rebates, discounts, deals and other financial incentives, referred to generally as coupons, are often used by merchants, manufacturers or other offerors, as marketing tools to entice or otherwise incentivize consumers to purchase or try products or services, such as by rewarding existing customers and/or attracting new customers. Typically, these financial incentives are effected via a paper certificate/document/ticket or card which provides details about the offer and which the consumer exchanges, or otherwise presents, to a merchant, retailer or other redemption entity, in order to obtain the financial incentive, such as at the time of purchase, or in the case of a rebate, subsequent to the purchase. These coupons may be consumer- or consumer-group specific, e.g. customized to a specific consumer group or specific consumer such as by identifying the consumer, including a consumer-customized offer or including a consumer-specific code, or may be generic and widely published, such as via a newspaper. Regardless, coupons may provide a merchant, manufacturer or other entity with the ability to offer the financial incentive to a subset of consumers, e.g. those most likely to be interested in the associated product or service, control redemption, e.g. so as to minimize losses, and benefit from the marketing effect, e.g. increase sales to existing customers and/or obtain new customers.

In the online/e-commerce context, financial incentives may be distributed, physically or electronically, as codes which the consumer enters, for example, by typing the code into a designated form field when purchasing a product, via a web page for example, to obtain the financial incentive. In the mobile context, financial incentives, e.g. the codes therefore, may be distributed via a mobile device, such as via e-mail, SMS text message, mobile web browser or a proprietary application, e.g. “app”, executing on the device.

Regardless of the type of financial incentive or the medium of distribution, to maximize benefits to the offeror and minimize losses due to fraud, the distribution of the offer of a financial incentive should be controlled and redemption thereof should be managed and tracked while minimizing the burden on the offeror and/or redemption entity.

### BRIEF DESCRIPTION OF THE DRAWINGS

FIG. 1 depicts a block diagram of a system for managing an offer for a financial incentive.

FIG. 2 depicts a flow chart showing operation of the system of FIG. 1.

FIG. 3 depicts a block diagram of a system for providing an offer for a financial incentive.

FIG. 4 depicts a flow chart showing operation of the system of FIG. 3.

FIG. 5 depicts an exemplary computer system for use with the system of FIG. 1.

### DETAILED DESCRIPTION OF THE DRAWINGS AND PRESENTLY PREFERRED EMBODIMENTS

The disclosed embodiments relate to management of an offer for a financial incentive offered by a merchant, manufacturer, retailer or other offeror and, in particular, to a system and method for managing redemption of the offer by a particular user/consumer which eliminates the need for a redemption entity to capture a user-unique redemption code or otherwise report redemption in order to track and control the user's redemption of the offer. Instead, as will be described in detail below, in one embodiment the user's revelation of the redemption code, via a device associated with the user, may be considered a redemption of the financial incentive by the user regardless of whether the user actually receives the incentive. In an alternate embodiment, an electronic multiple purchase/frequent transaction, e.g. “punch card,” function is provided that provides the user with a reward or other offer upon satisfaction of an offeror defined criterion, such as a free product once the user has purchases a set number of the products, and, as will be described below, relieves the offeror from tracking the user's progress towards satisfaction of the goal and providing the offer upon satisfaction.

In particular, in one embodiment, offers for financial incentives may be provided in an electronic form to a user, via a device associated with the user, such as the user's personal computer or mobile device, from an offer server, such as via a wired and/or wireless network. The offer includes a redemption code which must be exchanged or otherwise presented to the redemption entity, e.g. a merchant or retailer, to obtain the financial incentive. Upon delivery of the offer to the user's device, the redemption code is concealed from the user by the device such that user must take some subsequent action to reveal the redemption code, ideally in the presence of the redemption entity, i.e., the merchant/retailer, or otherwise substantially contemporaneously with the purchase, e.g. for web based transactions. In one embodiment, the user's attempt to reveal the redemption code causes the device to validate the offer with the offer server which determines whether or not the offer is valid, e.g. is redeemable, and, if valid, causes the offer server to log the offer as having been redeemed by the user. If the offer server responds to the device that the offer is valid, the device may reveal the redemption code so that the user can present it to the merchant/retailer, otherwise the device may be prevented from revealing the redemption code. If the server responds to the device that the offer is invalid or otherwise not redeemable, e.g. expired or previously redeemed, a suitable message may be displayed or provided informing the user thereof. In an alternative embodiment, the user's attempt to reveal the redemption code causes the device to validate the offer with the offer server wherein the offer server, if the offer is valid, responds as such but does not yet mark the offer as redeemed. Instead, the validation of the offer may cause the user's device to display a warning that the user's continued attempts to reveal the redemption code will reveal the code and cause the offer server to log the offer as having been redeemed, thereby affording the user an opportunity to abort the revelation/redemption process prior to revelation of the redemption code and avoid redemption thereof. Should the user continue to attempt to reveal the redemption code, the redemption code may be revealed contemporaneously, or at a later time, with a transmission by the device 104 to the offer server 102 of a message indicative thereof, the offer server 102, upon receipt of the message, updating the offer to indicate that it has been redeemed. In yet another alternate embodiment, the user's revelation of the redemption code may be subsequently reported to the offer server at a later time. In the case of a one-time offer, when the user navigates away from the revealed redemption code or otherwise clears the display, they are unable to subsequently re-reveal that redemption code, e.g. the offer/redemption code may be deleted or otherwise rendered inaccessible to the user. For example, the offer or redemption code may be partially displayed or obscured by a indication that the offer has been redeemed or has expired. As noted above, this may occur regardless of whether the user presents the offer to the redemption entity or actually receives the financial incentive. Upon presentment of the redemption code, the redemption entity, i.e. the merchant, provides the requisite financial incentive.

As used herein, the term “coupon” refers to any offer of a financial incentive related to the purchase of, or subscription to, a product or service, such as a discount, rebate, additional or complementary product or service, or combination thereof, which requires, contemporaneously with the purchase, the exchange or presentation, visually, audibly or via an input device, such as an optical scanner, RFID or other near field communication reader, or virtual or physical keyboard, of an indicia, such as a redemption code, identifying the offer, whether the indicia is unique to the bearer or not, whether the indicia is affixed to a paper, card or other physical medium or displayed via a display or otherwise emitted, broadcast, transmitted or annunciated by an electronic device. As used herein, a “electronic coupon” refers to a coupon wherein the indicia identifying the offer or required to be presented is displayed via, or emitted or annunciated by, an electronic device, such as a computer, e.g. desktop or laptop computer; network appliance, e.g. Internet enabled kitchen appliance, set top box or gaming console; or mobile device, e.g. cellular telephone, smart phone, tablet computing device, personal digital assistant, etc. In the context of mobile devices, electronic coupons may also be referred to as “mobile coupons.” A coupon may be offered by an offeror, such as a merchant, retailer, manufacturer or other entity, for redemption by a redemption entity, such as a brick and mortar or e-commerce merchant, retailer or other entity which may be the same as, different from, related to or unrelated to the offeror.

While electronic coupons, such as mobile coupons, have been implemented in a variety of ways, such as via SMS text messages, trackable redemption of these coupons has required that the merchant implement mechanisms to capture and validate the offer and/or the consumer unique redemption code associated therewith and presented by the consumer at the time of purchase, such as via their point of sale (“POS”) system, to ensure that the consumer is entitled to the financial incentive. Not only does this require that the merchant modify their POS system, such as to include a function to capture the redemption code and provide a network interface to connect with a back end system for validation and logging/recording of redemption, but this also introduces delay in the check-out process which, depending on the type of product, the merchant may not find tolerable, e.g. the check-out lines or waiting times may be too long causing some customers to abandon their purchases.

The disclosed embodiments encourage the user to redeem an offer for a financial incentive substantially contemporaneously with the controlled revelation of a concealed redemption code and, thereby, substantially contemporaneously, e.g. prior to or along with payment, with the corresponding purchase, ensuring that the redemption entity, i.e. the merchant/retailer, provides the appropriate financial incentive only to the user bearing the revealed redemption code and allowing for the tracking and control of the redemption independent of the merchant's point of sale system. This obviates the need for the merchant to implement a mechanism for validating redemption codes with the offer server prior to providing the financial incentive and eliminates the need to use user-unique redemption codes to control and track the user's redemption of the offer. In the case of merchants which already offer financial incentives via redemption codes, such as via paper or mobile coupons, which their POS systems are already configured to receive so as to automatically apply the financial incentive, the same codes may be used by the disclosed embodiments further minimizing the burden on the merchant while improving the ability to manage redemption as described herein. It will be appreciated that, for merchants which permit redemption of offers, such as general discounts or credits, in advance of a specific purchase whereby the redeemed offer is credited to a user's account, such as in the form of a monetary credit, and available to be used for a purchase at a later time, the transaction by which the offer is credited to the account may be considered the redemption event for purposes of this disclosure. For example, Amazon.com permits the redemption of monetary credits where the redeemed credit is held on account for the user to be used for a subsequent purchase which may not be contemporaneous with the redemption.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

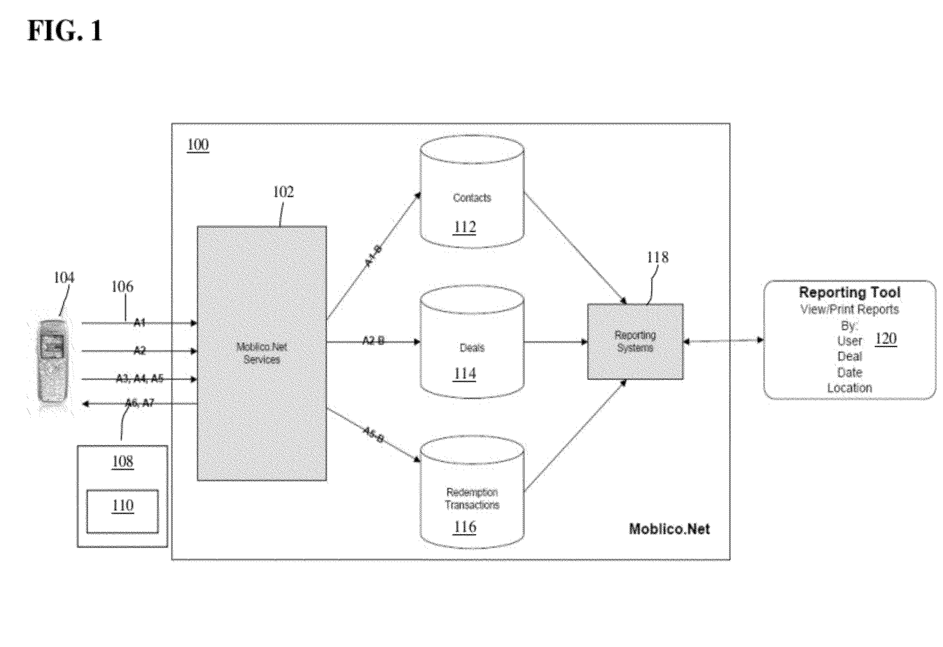

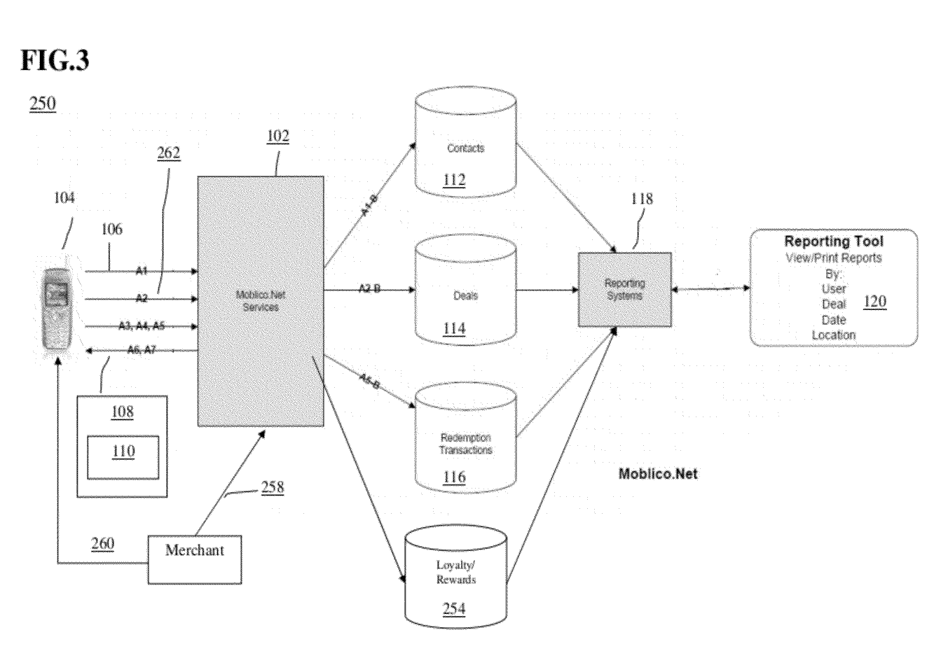

Referring to FIG. 1, there is shown a block diagram of one embodiment of a system 100 for managing an offer for a financial incentive, such as a mobile coupon for a price discount for a product or service offered by an offeror, such as a merchant, retailer, manufacturer or combination thereof. The system 100 includes an offer server 102 which is coupled with a device 104, such as a computer, e.g. desktop or laptop computer; network appliance, e.g. Internet enabled kitchen appliance, set top box or gaming console; or mobile device, e.g. cellular telephone, smart phone, tablet computing device, personal digital assistant, electronic book reader, etc., or other proprietary or non-proprietary wired or wireless communications device, via a wired and/or wireless network 106. Herein, the phrase “coupled with” is defined to mean directly connected to or indirectly connected through one or more intermediate components. Such intermediate components may include both hardware and software based components. In one embodiment, the offer server 102 may be implemented as computer program logic or computer readable program code stored in the memory and/or storage of a computer, such as the computer 400 described below with respect to FIG. 3, and executable by one or more processors thereof to implement the disclosed functionality. The system 100 may further include a contacts database 112, a deals database 114, a redemption transaction database 116, a reporting system 118 and a reporting tool 120. While the contacts, deals and redemption transaction databases 112, 114, 116 are depicted separately, it will be appreciated that they may be implemented as a single database having one or more tables, on single or multiple storage devices or memories. The contacts database 112 may store and/or maintain contact information, such as network identifiers, e.g. IP addresses, telephone numbers, electronic serial numbers, email addresses, etc., for registered users and/or their devices 104. The deals database 114 may store and/or maintain data representative of the various financial incentives available to be provided by the system 100 and may also store data representative of previously available financial incentives. The redemption transactions database 116 may store data representative of the redemption of offers by the users as described herein. The reporting system 118 may be accessed by offerors or other entities, such as via the reporting tool 120, which may comprise a user interface, to report on, add, remove or modify registered users in the contacts database, report on, review, add, modify or remove deals in the deals database 114, and/or report on or review redemption data stored in the redemption transactions database 116, as described in more detail below.

The device 104 may be associated with a user interested in receiving offers for financial incentives, such as a user who registers themselves and/or their device 104 with the offer server 102 or is otherwise represented in the contacts database 112. The network 106 may be a wireless network or a combination of a wired and wireless network, such as a cellular telephone network and/or 802.11x compliant network, and may include a publicly accessible network such as the Internet, a private network, or combination thereof. It will be appreciated that the type and configuration of the communications network 106 is implementation dependent and any type of communications network which facilitates the described communications between the offer server 102 and the device 104, available now or later developed, may be used. The offer server 102 may communicate with the device 104 using native or modified communications functionality of the device 104, such as using the short message service (“SMS”) or multimedia message service (“MMS”) text message protocol, the hyper text transport protocol (“HTTP”) via a web browser application provided by the device 104, the simple mail transfer protocol (“SMTP”), or other email communications protocol, via an email application, provided by the device 104, via a proprietary application (“app”) specifically installed on the device 104, which may use a proprietary or non-proprietary protocol, to implement the disclosed functionality, via the telephony functions of the device 104, such as via touch-tone or interactive voice response mechanisms, or a combination thereof.

The offer server 102 is operative to transmit, based on the data stored in the contacts database 112, such as via SMS, HTTP, or other proprietary protocol, non-proprietary protocol, or combination thereof, to the device 104, data 108 representative of one or more offers for financial incentives, which may be stored in the deals database 110. The offer server 102 may transmit the data 108 in response to a request received from the device 104, e.g. “pull,” and/or transmit the data 108 automatically, such as on a periodic schedule or in response to an event or other signal, e.g. “push.” The data 108 comprises at least a redemption indicia 110 operative to be presented, e.g. visually, audibly, via entry using a user input mechanism and/or via radio frequency transmission, such as RFID, near-field communications (“NFC”), Wi-Fi or Bluetooth, to a merchant or other redemption entity to obtain the financial incentive. The data 108 may further include a description of the offer, in the form of text and/or one or more graphic images or animations, and any conditions and/or instructions thereon to be displayed on, or evaluated or implemented by, the device 104, such as start/availability date, expiration date, number of allowed redemptions, required criterion, and/or progress with respect thereto, to satisfy an offeror-defined requirement to receive the offer as will be described below, etc. The data 108 may also include data specifying and/or describing conditions or restrictions, stored in the deals database 114, which control the user's ability to cause the device 104 to reveal the redemption indicia 110 as will be described in more detail below. The device 104 is further caused, as will be described below, to conceal the redemption indicia 110, e.g. inhibit the presentation thereof, until the user causes the device 104, possibly subject to conditions as will be described, to reveal the redemption indicia 110 for presentation. It will be appreciated that, for some offers, some or all of the parameters of the offer may also be concealed along with the redemption indicia. For example, the extent or amount of an offered discount may be concealed from the user until revelation. The offer server 102 is further operative to determine whether the user has caused the device 104 to reveal the redemption indicia 110 for presentation and, based thereon, account for the redemption of the offer by the user, such as by storing data indicative thereof in the redemption transactions database 116. For example, as will be described, the device 104 may send a signal or message to the offer server 102 when the user attempts to, or is successful in, revealing the redemption indicia. This signal or message may identify the user and/or the device 104 and may include additional information relating to the revelation of the indicia, such as the date or time, GPS coordinates or other location data provided by the device 104 indicative of the location thereof, confirmation information entered by the user or merchant as described below, or other information. In one embodiment, the offer server 102 invalidates the offer for subsequent revelation or redemption based on the determination that the user has caused the device to reveal the redemption indicia regardless whether or not the user has actually received the financial incentive. In an alternate embodiment permitting a limited or unlimited number of redemptions, the offer server is further operative to adjust a count of the number of redemptions of the offer, which may be stored in the redemption transactions database 116, based on the determination that the user has caused the device 104 to reveal the redemption indicia. In the case of a limited number of redemptions, the offer server 102 may further compare the number of redemptions against a threshold and invalidate the offer for the current or subsequent revelation or redemption if the number of redemptions equals or exceeds the threshold, or, in the case of a redemption count which is decremented with each redemption, if the number of remaining redemptions is zero.

In one embodiment, the offer server 102 must enable the device 104 to reveal the redemption indicia. In particular, the offer server 102 may be further operative to, prior to the determination that the user has caused the device 104 to reveal the redemption indicia, determine that the user is attempting to cause the device 104 to reveal the redemption indicia, such as by receiving a signal from the device 104 generated in response to the user attempting to reveal the redemption indicia, the signal identifying the offer, the device 104, the user or a combination thereof. The offer server 102 may then determine whether the offer associated with the redemption indicia is valid and enable the device 104 to reveal the redemption indicia if the offer associated with the redemption indicia is valid and otherwise prevent the device 104 from revealing the redemption indicia, such as by transmitting a signal indicative thereof back to the device 104 which is responsive thereto. In one embodiment, if the offer is valid, the offer server 102 may cause the device 104 to warn the user that their continued attempts to reveal the redemption indicia will result in redemption of the offer, thereby affording the user an opportunity to abort their attempt and avoid redemption, e.g. if the attempted revelation of the redemption indicia was made in error. Such mechanisms to prevent unintended revelation may be important in embodiments where offers are considered to have been redeemed regardless of whether the redemption code was actually presented or the financial incentive actually received. In one embodiment, the redemption code must be revealed for a minimum amount of time to be considered revealed and if the user re-conceals the redemption code, e.g. by navigating away from the display thereof, prior to the elapse of the specified minimum amount of time, the redemption of the offer will not be considered to have occurred. In one implementation, a timer may be displayed showing the elapse of time or other indication of the opportunity to preserve the offer for later redemption.

In one embodiment, attempted revelation of the redemption indicia may be treated as having successfully done so. For example, the offer server 102 may be further operative to determine that the user has caused the device 104 to reveal the redemption indicia based on receipt of a message from the device 104 indicating that the user has at least attempted to cause the device 104 to reveal the redemption indicia, the message having been automatically transmitted in response thereto.

In one embodiment, once the data representative of the offer is transmitted by the offer server 102 to the device 104, the user may be able to cause the device 104 to reveal the redemption indicia without further interaction with the offer server 102. This enables the user to reveal the redemption indicia in situations where the ability of the device 104 to communicate is compromised, e.g. in areas of intermittent or no network connectivity, no cellular or Wi-Fi signal, etc. In one embodiment, this ability to reveal the redemption indicia may be allowed only after the device 104 first attempts but then fails to validate the offer with the offer server 102. The device 104 may then transmit a message, indicating that the user has revealed the redemption indicia, to the offer server 102 once the device 104 is again able to communicate or at a later time. Alternatively, when the device 104 cannot validate the offer with the offer server 102, the user is prevented from revealing the redemption indicia and, for example, may be presented with a message indicating that the offer is currently unredeemable and that they should try again at a later time.

In the case of a one-time offer or, in the case of a limited offer, where the allocated redemptions have been exhausted or, as will be described below, a goal based offer where the user has already satisfied the goal and received the offer, the offer may be deleted from the device 104 or otherwise rendered inaccessible or unviewable once the user navigates away from the display of the revealed indicia or otherwise performs some other action with their device 104 which changes the display. In one embodiment, the offer and/or redemption indicia 110 may remain at least partially viewable/obscured by an indication that the offer has been redeemed or is expired. In the case of a time limited offer where the time limit has expired, the offer may be deleted from the device or otherwise rendered inaccessible or unviewable regardless of whether the user has revealed the indicia 110. For limited time offers or offers featuring multiple redemptions, an indication of the remaining time or number redemptions may be provided. The rendering of an offer as inaccessible or unviewable, etc. or the presentation of indications thereof or of remaining time or remaining redemptions, may be performed by the device 104, such as by an “app” executing on the device 104, based on the conditions transmitted with the offer, e.g. by comparing the expiration date with the current date, by the offer server 102 via transmission of data operative to cause the device 104 to render the offer inaccessible or unviewable or present the requisite content, or a combination thereof.

The redemption indicia 110 may include an alphanumeric code, a machine readable code, such as bar code or QR code, an image, an audible message, a signal operative to be transmitted via a radio frequency or other medium, or combination thereof. In one embodiment, the redemption indicia 110 is unique to the user and/or device 104. In one embodiment, once revealed, as will be described below, the user presents the redemption indicia 110 to the merchant, retailer or other redemption entity, by displaying the redemption indicia 110 on the display of their device 104, or otherwise causing the device 104 to emit or annunciate the redemption indicia, so that the merchant, or representative thereof, is able to perceive it, e.g., view, read, scan, receive and/or hear it. In an alternative embodiment, the user presents the redemption indicia 110 to the merchant by viewing it on the of the display of their device 104 and manually entering, e.g. typing or clicking a mouse button, the redemption indicia 110, e.g. redemption code, via a user input device (not shown), such as a pin-pad, key pad or keyboard provided at a point of sale, or a data input field/object provided on a merchant web page.

In one embodiment, the user causes the device 104 to reveal the redemption indicia by performing a specific interaction with the device 104 such as selecting the offer from a list presented via a user interface of the device 104. To prevent the user from accidentally revealing the redemption indicia 110, a second confirmatory action by the user may be required, prior to or after validation with the offer server 102, such as selecting a “yes” option on the user interface of the device 104 in response to an “are you sure?” query. In one embodiment, multiple actions may be required to reveal the redemption indicia wherein the first action is considered an attempt to reveal the redemption indicia triggering the validation protocol described above and wherein a subsequent action may only be performed to ultimately reveal the redemption indicia once the offer has been validated by the offer server 102. In one embodiment, the user interface of the device 104 featuring a touch screen display or other interactive display is caused, such as by an offer application executing thereon, to present a simulated scratch off display, the illusion of which gives the appearance that the redemption code is displayed “underneath” the simulated scratch off covering. The user then interacts with a display using rubbing or scratching motions to progressively reveal the redemption indicia, the first of which may trigger the validation protocol wherein, if the offer is invalid, a message indicative thereof is displayed “underneath” the scratch off cover instead of the redemption indicia. The application may be programmed to ensure that a specific number of “scratches” are required to fully display the redemption indicia in a redeemable form, e.g. each scratch interaction causes a configurable and/or variable percentage of the indicia to be revealed. It will be appreciated that other user interactions, simulated or otherwise, may be implemented which facilitate and confirm the user's intention to reveal the redemption indicia and minimize accidental revelation thereof. In one embodiment for use on devices 104 which may or may not feature a touch sensitive display screen, the user may repeatedly press a key or button, move a mouse or other user input device, or otherwise undertake a series of interactions with the device 104 via an available user input mechanism of the device 104 to initiate and complete, e.g. progressively, the reveal operation. For example, for devices 104 featuring motion sensors, such as accelerometer or gyroscope sensors, the user may shake or otherwise move the device 104. In one embodiment for devices featuring GPS capability, the user may simply need to physically bring the device 104 to, or remove the device 104, from a specific geographic location or region upon which the redemption indicia is automatically revealed. This may be set as a condition of the offer by an offeror which only wants the offer to be valid for one visit to the location, such as a particular retail venue, whether or not the user redeems the offer.

Other mechanisms may also be provided to control revelation of the indicia 110, e.g. minimize accidental revelation of the redemption indicia or otherwise minimize the occurrence of fraudulent or otherwise improper redemption or obtaining of the financial incentive by the bearer or a consumer other than the bearer. In one embodiment, the data representative of the offer for the financial incentive may further include one or more conditions to be satisfied to enable the user to cause the device to reveal the redemption indicia. For example, the offer may be time limited whereby upon lapse of the offer, it may no longer be revealed. Alternatively, or in addition thereto, the user may need to enter a code into an application executing on the device 104 wherein the code is only provided by the redemption entity at the time of the purchase or is otherwise only available within a physical location, such as displayed on a sign within a retail establishment, In one embodiment, the user may be required to provide their device 104 to the merchant, or representative thereof, who enters the code themselves or performs some other confirmatory action. In an alternative embodiment, the condition may comprise a substantial match or convergence between specified geographic coordinates or coordinate ranges/geographic boundaries and coordinates provided by a GPS or other location determining device contained within the device 104. For example, the condition may include the geographic coordinates of one or more retail locations of the merchant such that the user may only reveal the redemption indicia when their device 104, and presumably the user themselves, are physically located within or substantially proximate to one of the specified retail locations. Given the inherent imprecision of GPS and other location determining devices, only a substantial match may be required, such as within 100 feet or less of the specified coordinates or being within a defined geographic boundary. GPS/geographic based conditions may, alternatively, be used to prevent redemption in particular locations or regions. It will be appreciated that there may be other conditions that may be implemented, alone or in combination, to ensure the presence of the user/device 104 at a given location or region such as the detection of a specific available Wi-Fi network within range of the device 104. In one embodiment, the device 104 may be enabled, such as via an “app” program executing on the device 104, to evaluate the satisfaction of the conditions and determine if they are satisfied in order to enable the redemption indicia to be revealed. In an alternate embodiment, the device 104 collects and transmits data to the offer server 102 which determines if the conditions have been satisfied and returns a message back to the device 104 to enable or prevent revelation of the indicia depending on the result. In yet another alternative embodiment, the device 104 and offer server 102 may collaborate on the evaluation of the conditions to determine the satisfaction thereof. It will be appreciated that offer conditions, including GPS based conditions, may apply to the offer generally or may vary depending on the user and that such conditions may be used to segregate offers among users or otherwise segment markets to control redemption, such as to limit redemption to particular geographic areas and/or markets. For example, a travel related offer may be limited to redemption anywhere except the user's home city.

In one embodiment, the user may first register with the offer server 102, such as via a web page, device-based application (“app”), telephone call, SMS or MMS text message, electronic mail submission or other interaction with the offer server 102, that they are interested in receiving offers for financial incentives. The registration may be stored in the contacts database 112. The offer server 102 is operative to register the device 104 associated with the user, such as by registering the email address, telephone number, device identifier and/or IP address associated therewith, and store, in the contacts database 112, an association between the user and any offers for financial incentives subsequently transmitted to the user's device 104 as described. As part of the registration, the offer server 102 may further receive user data representative of at least one of the user's interests, preferences, demographics, biographical information, or combinations thereof, e.g. a user profile, such as via an interactive survey or questionnaire, whereby the offer server 102 may determine or otherwise select particular offers, such as from among those stored in the deals database 114, to be transmitted to the user's device 104 from a plurality of offers available to be provided to the user based on the received user data. In one embodiment, the offer server 102 may generate offers unique, or substantially unique, to the user, or a group of users, based on the received user data.

Other mechanisms may be provided for preventing fraudulent or otherwise improper redemption/obtaining of the financial incentive by a consumer bearing the redemption indicia or a consumer other than the bearer. In one embodiment, the offer server 102 may be further operative to receive data indicative of the redemption of the offer from the merchant, such as via the reporting tool 120 and reporting system 118, such as on a periodic schedule, and reconcile the received data with the accounted for redemption by the user, which may be stored in the redemption transactions database 116. The offer server may be further operative to detect fraudulent redemption based on the reconciliation such as by detecting that the offer has been redeemed more than the number of offers transmitted or, in the case where unique redemption indicia are utilized, that an identical redemption indicia has been presented by more than one user. In the case where the offeror is not the redemption entity, the reconciliation may be used to detect fraudulent redemption by the redemption entity, such as where the redemption entity seeks reimbursement for having provided the financial incentive when, in fact, they have not done so. The offer server may also be further operative to determine marketing effectiveness of the offer based on the reconciliation, such as by tracking the frequency of redemption as a function of the number of offers and the demographics of the offerees.

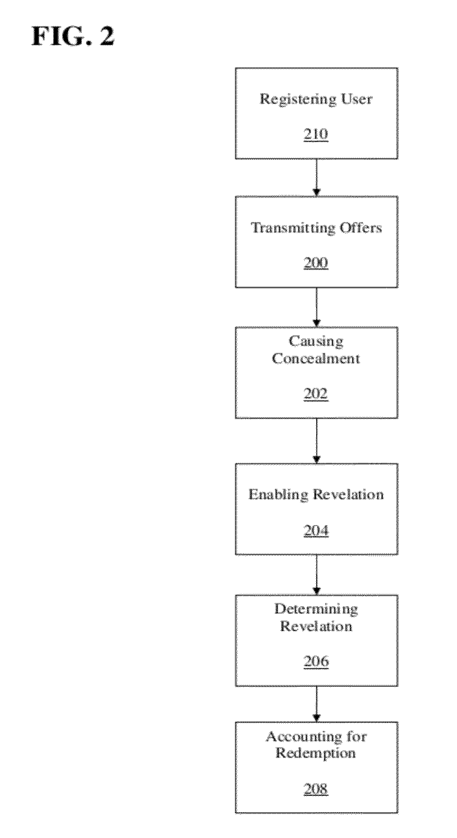

Referring to FIG. 2, there is shown a flow chart depicting the operation of the system 100 for managing an offer for a financial incentive according to one embodiment. In one embodiment, the system 100 includes an offer server 102, implemented as a computer having a processor and a memory coupled therewith. The operation includes transmitting, such as via the execution by the processor of first logic stored in the memory, to a device 104 associated with a user, such as a mobile device 104, interested in receiving offers for financial incentives, by the computer, data 108 representative of the offer for the financial incentive (block 200), wherein the data comprises at least a redemption indicia 110 operative to be presented to a merchant to obtain the financial incentive, and causing the device 104 to conceal the redemption indicia 110 until the user causes the device 104 to reveal the redemption indicia 110 (block 202). The financial incentive may include a price discount for a product or service offered by the merchant. The redemption indicia 110 may be unique to the user and may include an alphanumeric code, a machine readable code, an image, an audible message, a signal operative to be transmitted via a radio frequency, or combination thereof. The transmitting may be in response to a request received from the device 104. The transmitting of the data may be performed via an application executing on the device 104, such as a proprietary application program or a web browser program. The data representative of the offer for the financial incentive may further include a description of the offer operative to be displayed by the device 104 and/or include a condition to be satisfied to enable the user to cause the device 104 to reveal the redemption indicia 110. The condition may include a substantial convergence between specified geographic coordinates and coordinates provided by a GPS device contained within the device. Alternatively, or in addition thereto, the condition may include performance of a confirmatory action by the merchant. In one embodiment, the operation of the system 100 may further include enabling the device 104 to reveal the redemption indicia 110 in response to a specific user interaction with the device 104, such as a simulated scratching motion on an interactive display of the device 104 (block 204).

The operation of the system 100 further includes, determining, by the computer, that the user has caused the device to reveal the redemption indicia 110 (block 206) and accounting, by the computer, for the redemption of the offer by the user based thereon (block 208), such as by invalidating the offer for subsequent redemption and/or adjusting a count of the number of redemptions of the offer.

The operation of the system 100 may further include registering, by the computer, the device associated with the user, the computer storing an association between the user and the offer for the financial incentive represented by the transmitted data (block 210). The registering may further include receiving user data representative of at least one of the user's interests, preferences, demographics, biographical information, or combinations thereof, and/or prior to the transmitting, determining the offer from a plurality of offers available to be provided to the user based on the received user data.

The operation of the system 100 may further include, prior to the determining that the user has caused the device to reveal the redemption indicia, determining that the user is attempting to cause the device to reveal the redemption indicia 110, such as by receiving a message from the device indicating that the user has at least attempted to cause the device to reveal the redemption indicia 110, the message having been automatically transmitted in response thereto; determining whether the offer associated with the redemption indicia 110 is valid; and enabling the device to reveal the redemption indicia 110 if the offer associated with the redemption indicia is valid and otherwise preventing the device from revealing the redemption indicia 110.

The operation of the system 100 may further include receiving data indicative of the redemption of the offer from the merchant; and reconciling the received data with the accounted for redemption by the user to, for example, detect fraudulent redemption and/or determine marketing effectiveness of the offer, based on the reconciling.

Referring to FIG. 3, there is shown a block diagram of another embodiment of a system 250 for providing an offer for a financial incentive. The system 250 may be used, for example, to provide offers for financial incentives to a plurality of users (e.g., customers, consumers, etc.) as part of an electronic customer loyalty, rewards, or discount program involving one or more merchants (e.g., service providers, manufacturers, retailers, and/or combinations thereof).

The system 250 includes the offer server 102 which, as noted above, is coupled with the mobile device 104 via the network 106. The system 250 further includes the contacts database 112, the deals database 114, the redemption transaction database 116, the reporting system 118, the reporting tool 120, and a loyalty or rewards database 254. The database 254 may store and/or maintain rewards data (e.g., points, dollars, etc.) for any of the plurality of users and/or may store or maintain transaction or purchase history information or data (e.g., quantity, price or cost data, etc.) for goods and/or services purchased by any of the plurality of users at any of the one or more merchants.

The offer server 102 is operative to receive data 258 from the one or more merchants. The data 258 is representative of one or more offer generation criteria or offer criteria established by one or more of the merchants for a plurality of users. Each offer generation criterion or offer criterion is associated with one or more products and/or services offered, provided, or sold by the merchant and/or a group or chain of the merchants. Each of the one or more merchants may have the same or different offer generation criteria for the same or different products and/or services. Each offer generation criterion is associated with an offer for a financial incentive, such as a mobile coupon for a product or service offered, provided, or sold by the one or more merchants. Each of the one or more merchants may also associate a similar or different offer for the financial incentive with similar or different offer generation criterion. When the one or more offer generation criteria is satisfied, met, or reached, the offer server 102 is operative to provide or generate the associated offer for the financial incentive, as will be described below.

The offer generation criterion may define or specify a quantity of a product or service (e.g., 10 small cups of coffee), a quantity of products or services (e.g., 10 small cups of coffee and/or 5 hash browns), a number of transactions (e.g., 5 purchases), a total purchase amount ($50), a number of rewards dollars or points (e.g., 50 rewards points), some other purchase value and/or threshold, which may or may not be time limited, and/or a combination thereof, purchased, earned, or made at the one or more merchants. The offer generation criterion may, alternatively or additionally, be location specific (e.g., 10 small cups of coffee must be purchased at a particular merchant location), may be specific to one particular merchant (e.g., Dunkin Donuts), or may be specific to a group, alliance, chain, and/or organization of merchants (e.g., Lettuce Entertain You Restaurants). The offer generation criterion may, alternatively or additionally, correspond to a purchase made or a transaction conducted at the one or more merchants during a defined or specific time period (e.g., between the hours of 12 P.M. and 2 P.M. every day and/or X number of days, weeks, months), may be open-ended (e.g., the purchase may be made at any time, without restrictions), or some combination thereof.

The offer generation criterion established by the one or more merchants may be the same for each user of the plurality of users or may be different for some users based on, for example, the user's determined value or “loyalty” to the merchant, the issue or generation date (e.g. offer generation criterion may differ from day-to-day, week-to-week, season to season, etc.), and/or the users preferences, purchase history, etc. For example, the merchant may establish a first offer generation criterion that specifies that a first user, a “new” customer, purchase 5 cups of coffee before the offer for the financial incentive is to be generated, while the merchant may, at the same time, establish a second offer generation criterion that specifies that a second user purchase 10 cups of coffee before the offer for the financial incentive is to be generated.

The data 258 may be received from the merchant via, for example, the reporting tool 120 or a server associated with the one or more merchants and in communication with the offer server 102. The data 258 may be automatically transmitted to, and received by, the offer server 102, such as on a periodic schedule or in response to an event or other signal and/or transmitted to, and received by, the offer server 102 in response to a request sent from the offer server 102 to the merchant.

The one or more merchants may provide or transmit to a respective user, via his/her associated mobile device 104, data 260 when the respective user completes one or more required tasks, such as a purchase, made by the respective user, of one or more products and/or services at the merchant, a visit, by the respective user, to the one or more merchants (e.g., to a webpage and/or a store of the one or more merchants), a donation (e.g., to charity) made by the respective user, or combinations thereof. Other tasks may be used.

The data 260 may be an alphanumeric code, a machine readable code (e.g., a bar code or a QR code), an image, an audible message, a signal operative to be transmitted via a radio frequency or other medium, or combinations thereof. The alphanumeric code, machine readable code, image, message, signal, or combinations thereof may, in some embodiments, include information (e.g., embedded information) such as a merchant identifier, store identifier, product identifier, product cost, total purchase amount, product quantity purchased, or combinations thereof. The data 260, or portions thereof, may vary with each transaction, with each product or service, with each group of products and/or services, based on the one or more offer generation criterion (i.e. may vary with each promotion), periodically (e.g. once a week), and/or a combination thereof to prevent users from copying the data 260 or using the data 260 in an un-authorized manner so as to fraudulently generate the one or more offers for financial incentives. The data 260, or portions thereof, may be automatically varied (e.g., by the cash register at the merchant) or may be manually varied by an employee of the merchant. Alternatively, the data 260, or portions thereof, may be fixed so as to make it easier for the employee of the merchant to provide the data 260 to the user.

As noted above, the data 260 is provided or transmitted to the respective user, via his/her associated mobile device 104, by the one or more merchants. To this end, the user may first provide or present his/her associated mobile device 104 to the merchant at, proximate to (including both before and after), or simultaneous with the completion of the one or more required tasks (e.g., the purchase, transaction, visit, etc.). The user may, in some embodiments, provide or present the merchant with the app executing on his/her mobile device 104.

When the mobile device 104 (e.g., the app executing thereon) or the one or more merchants (via, e.g., the cash register) indicate and/or the employee of the one or more merchants are aware or instructed that the one or more products or services are the subject of one or more offer generation criterion, the data 260 may be provided to the respective user. The data 260 may be manually provided to the user by an employee (e.g., cashier) of the one or more merchants via, for example, a sign or card, or may be automatically provided to the user by the one or more merchants (e.g., automatically printed on, for example, a receipt given to the user). The data 260 may, in one embodiment, be located or found on or in the one or more products or services (e.g., the data 260 may be located on a label of the product). In turn, the data 260 may be typed, scanned, captured (via, e.g., a camera of the mobile device 104), or otherwise entered or selected into mobile device 104 (e.g., into the app executing on the device 104) by the user and/or the employee of the one or more merchants.

In one embodiment, the user may provide the employee of the merchant with his/her virtual “punch” card (executing on the mobile device 104), the employee may provide the user with the data 260, in the form of a QR code, after the user has purchased one or more qualifying products or services, and the user, using the virtual “punch” card, scans the QR code into the mobile device. The virtual “punch” card may then illustrate or indicate that the scan was successful (by, for example, displaying or illustrating an additional “punch,” corresponding to the most recent purchase, on the user's virtual card). This also serves to provide the user with data indicative of the user's progress towards satisfying or completing the respective offer generation criterion, as will be described in further detail below. In other embodiments, other mobile applications may be used.

Once the data 260 has been typed, scanned, captured (via, e.g., a camera of the mobile device 104), or otherwise entered or selected into mobile device 104 (e.g., into the app executing on the device 104) by the user and/or the employee of the one or more merchants, the one or more mobile devices 104 are operative to provide or generate data 262. The data 262 is thus generated or provided based on the scan, capture, entry, or selection of the data 260 into or the mobile device 104. Accordingly, the data 262 is indicative or representative of the completion of the one or more required tasks by the respective user, such as a purchase, made by the respective user, of one or more products and/or services at the one or more merchants, a visit, by the respective user, to the one or more merchants, a donation made by the respective user, other tasks, or combinations thereof.

The data 262 is, in other words, representative or indicative of at least partial satisfaction of the offer generation criterion by the respective user. The at least partial satisfaction of the offer generation criterion may be a greater than zero satisfaction (e.g., 10%, 25%), half satisfaction (50%), substantial satisfaction (e.g., 85%), or a full or complete satisfaction (100%) of the offer generation criterion. The data 262 may include information such as a user identifier, merchant identifier, store identifier, product identifier, product cost, total purchase amount, product quantity purchased, or combinations thereof, corresponding to or associated with the completed task—the purchase, transaction, donation, visit, etc.—by the respective user.

In turn, the one or more mobile devices 104 are operative to transmit, to the offer server 102, the data 262 via or over the network 106 and/or any other wired or wireless network. The mobile device 104 may, for example, transmit the data 262 via an app executing on the mobile device 104. Each mobile device 104 is associated with a respective user of the plurality of users. In some embodiments, the mobile device 104 may automatically transmit the data 262 to the offer server 102, such as, for example, immediately or a pre-determined period of time (e.g., five minutes) following the scan, entry, capture, or selection of the data 260 and/or periodically (e.g., once per day). In one embodiment, the mobile device 104 may automatically transmit the data 262 to the offer server 102 in response to a request for this data from the offer server 102. In other embodiments, the data 262 may be manually transmitted to the offer server 102 by, for example, the user of the mobile device 104 (using, for example, the app executing on the mobile device 104).

Alternatively, or additionally, the one or more merchants may provide or transmit the data 262 to the offer server 102. The data 262 may be provided or transmitted when the respective user completes one or more required tasks, such as a purchase, made by the respective user, of one or more products and/or services at the merchant, a visit, by the respective user, to the one or more merchants (e.g., to a webpage and/or a store of the one or more merchants), a donation (e.g., to charity) made by the respective user, or combinations thereof. Other tasks may be used.

The one or more merchants may automatically provide or transmit the data 262 in response to an event (e.g., immediately following the respective user's completion of the one or more required tasks) or other signal, on a periodic schedule (e.g., every 24 hours), in response to a request from or by the offer server 102, or combinations thereof. For example, the one or more merchants may automatically provide or transmit the data 262 when the respective user completes his/her purchase by paying his/her bill. In other embodiments, the one or more merchants may manually provide or transmit the data 262. Such a manual transmission may be performed in a response to an event (e.g., immediately following the respective user's completion of the one or more required tasks), on a periodic schedule (e.g., once a day at the close of business), in response to a request from the offer server 102, or combinations thereof.

The offer server 102 may be further operative, each time the data 262 is received from the mobile device 104, to store the data 262 in the database 254. The offer server 102 may, based on the received and stored data 262 and the mobile device 104 from which the data 262 was received, extrapolate or determine the respective user and a number of transactions or purchases, a number of products and/or services, a purchase or transaction amount, a number of rewards points or dollars, and/or a combination thereof associated with the data 262 and the respective user. Accordingly, the offer server 102 may adjust one or more counts stored in the database 254 as well. Each of the one or more counts may be associated with or correspond to one user and one offer generation criterion received from the one or more merchants. The one or more counts may include a count of a number of transactions or purchases, a number of products and/or services, a purchase or transaction amount, a number of rewards points or dollars, and/or a combination thereof made, purchased, spent, and/or earned, respectively, by the respective user at the respective one or more merchants and/or at one or more groups of merchants. The one or more counts may be initialized at a zero value or a pre-determined non-zero value (e.g., 10). The one or more counts may be incremented or decremented and may be compared with a threshold value, such as a zero value or a pre-determined non-zero value. When the one or more counts are initialized at a zero value and the offer server 102 receives and stores the data 262, the offer server 102 may increment or increase the one or more counts based on the data 262 until the one or more counts are equal to or greater than a pre-determined value or threshold. When, however, the one or more counts are initialized at a pre-determined non-zero value and the offer server 102 receives and stores the data 262, the offer server 102 may decrement or decrease the one or more counts based on the data 262 until the count is less than or equal to a pre-determined value or threshold (e.g. zero).

The offer server 102 is further operative to determine, each time the data 262 is received from the mobile device 104, whether the data 262 has caused the user to fully or completely satisfy one or more offer generation criteria for that user. The offer server 102 may determine, without regard or concern for any previous data 262 for that user stored in the transaction database 254 (i.e. without regard or concern for any previous at least partial satisfactions by the user), whether the at least partial satisfaction represented by the data 262 itself fully satisfies the one or more offer generation criteria for that user. If, for example, the offer generation criterion represented by the data 258 specifies that the user spend or purchase $25 at one specific merchant and the data 262 indicates that the user has made or completed a $30 purchase or transaction at this merchant, the offer server 102 may determine that the user has fully satisfied the offer generation criterion without looking to or considering any previous purchases or transactions made by the user. At the same time, the offer server 102 may determine, based on the at least partial satisfaction (e.g., a purchase) represented by the data 262 and one or more previous at least partial satisfactions (e.g., purchases or transactions) represented by the data stored in the database 254, whether the at least partial satisfaction (e.g., the purchase) represented by the data 262 has caused the user to fully satisfy the offer generation criterion for that user. In other words, the offer server 102 may determine whether the user's at least partial satisfactions—purchases, transactions, visits, donations, etc.—represented by the newly received data 262 and the data 262 previously received and stored in the database 254, and made at different times, fully satisfy or have fully satisfied the offer generation criterion for that user. As noted above, the data 262 may be received from the one or more merchants instead of from the mobile device 104 or may be received from the one or more merchants and the mobile device 104.

Regardless of whether the offer server 102 determines that the at least partial satisfaction (e.g., the purchase) represented by the data 262 has caused the user to fully satisfy one or more offer generation criteria for that user, the offer server 102 may, but need not, signify, illustrate, or otherwise indicate to the user that the one or more offer generation criteria has or has not been fully satisfied. The offer server 102 may, for example, provide the user, via the app executing on the mobile device 104, an audio and/or visual representation (e.g., a chart, graph, punch card) of data indicative of the user's progress towards satisfying or the user's completion or satisfaction of the one or more offer generation criterion. In one embodiment, the offer server 102 may provide the user, via the app executing on the mobile device 104 and on a display of the mobile device 104, with a list or total or rewards points or dollars earned and/or a rewards catalog that includes the one or more offer generation criteria. From this, the user may deduce or determine his/her progress towards fully satisfying the one or more offer generation criteria. In another embodiment, mentioned briefly above, the offer server 102 may provide the user, via the app executing on the mobile device 104, with the virtual “punch” card on a display of the mobile device 104. The virtual “punch” card may indicate or illustrate the one or more offer generation criteria and/or the user's progress towards fully satisfying the one or more offer generation criteria. If, for example, the one or more offer generation criteria specify that the user purchase 5 cups of small coffee at any Dunkin Donut's location, the virtual “punch” card may illustrate or depict the criterion and provide an indication of the user's progress with respect to that criterion. In other words, the virtual “punch” card may provide an indication of the offer generation criteria and depict or illustrate how many cups of coffee the user has purchased, and, thus, how many more cups of coffee the user needs to purchase to fully satisfy that criterion. If the user has previously purchased the 5 cups of coffee specified by the criterion, the virtual “punch” card may indicate that the user has fully satisfied or completed the one or more offer generation criteria, and is thus eligible to receive the associated one or more offers, as will be described below. In some embodiments, the offer server 102 may provide the user with the data indicative of the user's progress in response to a request made by the user, at any time, via mobile device 104 (e.g., via the application executing on the mobile device 104). In one embodiment, the user may request his/her progress from the offer server 102 at, proximate to, or simultaneous with the transaction or purchase (i.e. at or proximate to the time at which the data 262 is entered into the mobile device 104.

When the offer server 102 determines that the at least partial satisfaction represented by the data 262 has caused the user to fully satisfy the one or more offer generation criteria for that user, the offer server 102 is further operative to provide the data 108, which may be stored in the deals database 110 and is representative of one or more offers for financial incentives that may be redeemable at the one or more merchants associated with the satisfied offer generation criterion. In one embodiment, the offer server 102 may provide the data 108 to the mobile device 104 via the application executing on the mobile device. The offer server 102 may, depending on the configuration of the count (see above), provide the data 108 when the count is equal to or greater than the threshold value (when, for example, the count is initialized at a zero value) or when the count is equal to zero (when, for example, the count is initialized at a pre-determined non-zero value). As noted above, the data 108 is representative of one or more offers for financial incentives, such as, for example, a price discount for a future purchase, a coupon for one or more complimentary (i.e. free) products and/or services, and/or any other discount or coupon, redeemable by the user and/or at the one or more merchants. The one or more offers for financial incentives may expire after a specified time period (e.g., after X number of days, weeks, months, etc.) and/or may only be valid at or during specific time periods (e.g., between the hours of 12 P.M. and 2 P.M., on weekdays, etc.). The one or more offers may be provided, managed, and/or redeemed as described above in connection with the system 100.

When the offer server 102 determines that the at least partial satisfaction represented by the data 262 has not caused the user to satisfy one or more offer generation criteria for that user, the offer server 102 may, as noted above, store the data 262 in the database 254 and/or may signify, illustrate, or otherwise indicate to the user that the one or more offer generation criteria has not been satisfied and/or provide the user with an indication or illustration of his/her progress towards satisfying the one or more generation criteria. In this case, the offer server 102 does not provide the data 108 to the user. The offer server 102 is nonetheless operative to receive additional data 262 when the user completes one or more additional required tasks, such as an additional purchase, visit, donation, etc., or one or more other users of the plurality of users complete one or more of required tasks (e.g., make a purchase, visit, make a donation) at, to, or via the one or more merchants. When the additional data 262 is received, the offer server 102 is operative to determine whether this new data 262 has caused the respective user to fully satisfy the same or different one or more offer generation criterion for that user.

Once the offer server 102 determines that the purchase represented by the data 262 has caused the user to fully satisfy the one or more offer generation criteria for that user and the offer server 102 provides the user with the one or more offers for financial incentives associated therewith, the offer server 102 may “reset” or clear the user's progress towards satisfying the respective offer generation criteria. This may involve resetting the respective one or more counts (e.g., to the pre-determined zero or non-zero value), noting or indicating the satisfaction of the respective offer generation criteria in the database 254, and/or clearing or deleting some or all of the data 262 stored in the database 254. The offer server 102 may also notify the one or more merchants associated with the provided data 108 that their criteria has been fully satisfied and that the associated one or more offers have been provided or generated to the user.

The user may first communicate or register with the offer server 102 via, for example, a web page, the application executing on the mobile device 104, telephone call, SMS or MMS text, to indicate or express an interest in receiving one or more offers for financial incentives as part of the loyalty or discount program. In one embodiment, the user may send an SMS text to a provided mobile device number (e.g., 80802). By including a registration code (e.g., Moblico loyalty club) in the body of the SMS text, the user may indicate to the offer server 102 that he/she wishes to participate in the loyalty program. In response, the offer server 102 may, via return SMS or MMS text, email, a webpage, or the application executing on the mobile device 104, confirm the user's interest in participating, provide the user with instructions for the loyalty program (e.g., details about the existing one or more offer generation criteria), and/or provide the user with a link to download the mobile app and/or the software necessary to participate in the loyalty program. Alternatively, the user may request the instructions for the loyalty program, the link, and/or the software from the offer server 102. The offer server 102 may also provide the user with a registration form or request that the user complete registration questions or information, such that the offer server 102 may further receive user data representative of the user's biographical information (e.g., name, age), contact information, interests, demographics, and/or preferences, etc. In turn, the offer server 102 is operative to register the device 104 associated with the user, such as by registering the email address, telephone number, device identifier and/or IP address associated therewith, and store, in the contacts database 112, an association between the user and any offers for financial incentives subsequently transmitted to the user's device 104 as described.

In order to prevent the fraudulent or un-authorized generation of the data 108 (i.e. one or more offers for financial incentives) by one or more users and/or one or more merchants (and their employees), the offer server 102 may be further operative to monitor the frequency at which the data 262 is received from one or more users and/or the frequency at which the data 108 is generated or provided to one or more users. The offer server 102 may also limit the ability of the one or more users and/or one or more merchants to enter or provide the data 260 by, for example, only recognizing the receipt of the data 262 at certain times (during, for example, business hours) and/or a certain number of times over a defined period of time (e.g., 1 time per day). The offer server 102 may also notify the one or more merchants when possible fraudulent activity (due to the one or more users and/or one or more employees of the merchant) has been detected by the offer server.

Moreover, the offer server 102 may work with the one or more merchants to establish a process for detecting fraud and/or verify the propriety of the generated data 108. In one embodiment, the offer server 102 may receive, from the one or more merchants directly, data indicative of the at least partial satisfaction by the user at the one or more merchants. This may be done manually or automatically and/or following every purchase or transaction, donation, or event, or at periodic intervals (e.g. at the end of each business day). In turn, the offer server 102 may reconcile the data received from the one or more merchants with the data 262 received from the mobile device 104. If discrepancies exist between the data received from the one or more merchants and the data 262 received from the mobile device 104, the offer server 102 may determine, for example, that the data 262 is being improperly or fraudulently generated, and, more importantly, that the data 108 (including the one or more offers for financial incentives) is being improperly or fraudulently generated or provided to the user. The offer server 102 may, in turn, notify the one or more merchants that it has detected potential fraudulent activity based on the reconciliation of data. In other embodiments, the offer server 102 may utilize other data and/or different processes to detect the presence of fraudulent activity.

The offer server 102 may be further operative to monitor the behavior, habits, and/or participation of one or more users of the plurality of users in the electronic customer loyalty, rewards, or discount program. The offer server 102 may identify or determine the usage and popularity of the program (e.g., the number of completed required tasks, the number of offers for financial incentives generated) for one or more merchants, each merchant, and/or each chain or group of merchants. The offer server 102 may identify or determine the usage and popularity of specific offers for financial incentives within the program (e.g., identify or determine the number of completed required tasks and/or offers for financial incentives generated in connection with specific offer generation criterion). The offer server 102 may also, or instead, focus on individual users by, for example, identifying or determining where, when, how many, or combinations thereof, one or more users are completing required tasks (e.g., purchases, visits, transactions, donations) or, in other words, at least partially satisfying the one or more offer generation criteria.

The offer server 102 may, alternatively or additionally, identify or determine active users, as opposed to inactive users, of the loyalty, rewards, or discount program. The offer server 102 may differentiate active users from inactive users using any of a number of criteria, such as the last time the user completed one or more of the required tasks (e.g., the last time the user purchased something), the total amount of money the user has spent in the last year, frequency of participation in the loyalty, rewards, or discount program, etc., or combinations thereof. For example, the offer server 102 may identify users that have completed one or more of the required tasks in the last 6 months as active users.

In some embodiments, the offer server 102 may transmit or provide one or more users, via the respective user's associated mobile device 104, with an alert, reminder, or message (e.g., SMS, push notification, e-mail) when the offer server 102 determines that the respective user has become inactive (e.g., the user has not used the program in 6 months) and/or when the respective user is close to satisfying the one or more offer generation criteria. The offer server 102 may determine that the respective user is close to satisfying the one or more offer generation criteria when, for example, the user is within a pre-determined threshold (e.g., 1 purchase, 5 rewards points, $5, etc.) of satisfying the one or more offer generation criteria.

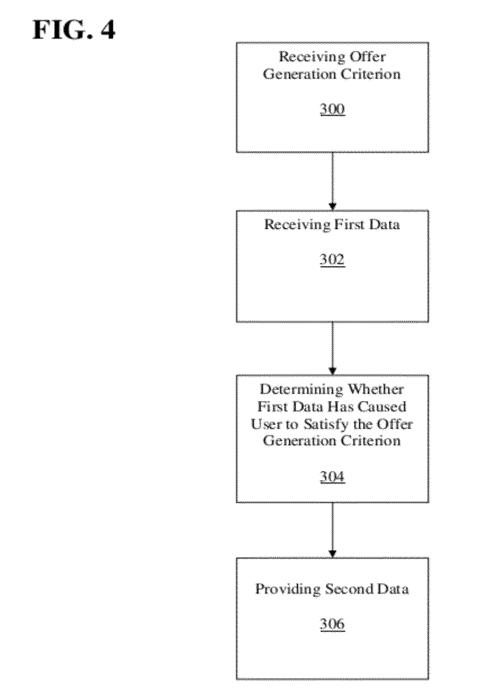

Referring to FIG. 4, there is shown a flow chart depicting the operation of the system 250 for providing an offer for a financial incentive according to one embodiment. In one embodiment, the system 250 includes an offer server 102, implemented as a computer having a processor and a memory coupled therewith.

The operation includes receiving, such as via the execution by the processor of first logic stored in the memory, by the computer, data 258 from one or more merchants (block 300). More specifically, the receiving may include receiving the data 258 from the merchant via, for example, the reporting tool 120 or a server or workstation associated with the one or more merchants and in communication with the offer server 102.

As described above, the data 258 is representative of one or more offer generation criteria established by one or more of the merchants for a plurality of users. Each offer generation criterion is associated with one or more products and/or services offered, provided, or sold by the merchant and/or a group or chain of the merchants. Each of the one or more merchants may have the same or different offer generation criteria for the same or different products and/or services. Each offer generation criterion is associated with an offer for a financial incentive, such as a mobile coupon for a product or service offered, provided, or sold by the one or more merchants. Each of the one or more merchants may also associate a similar or different offer for the financial incentive with similar or different offer generation criteria. The offer generation criterion may define or specify a quantity of a product or service, a quantity of products or services, a number of transactions or purchases, a total purchase amount, a number of rewards dollars or points, some other purchase value and/or threshold, and/or a combination thereof purchased, made, or earned at the one or more merchants. The offer generation criterion established by the one or more merchants may be the same or different for each user of the plurality of users. For example, the offer generation criterion established for a first user of the plurality of users may be different than the offer generation criterion established for a second user of the plurality of users. The offer generation criterion may be location specific, may be specific to one particular merchant, or may be specific to a group, alliance, chain, and/or organization of merchants. The offer generation criterion may correspond to a purchase made, a transaction conducted, and/or rewards points or dollars earned at or from the one or more merchants during a defined or specific time period, may be open-ended or without restriction, or some combination thereof.

The operation also includes receiving, such as via execution by the processor of second logic stored in the memory, by the computer, data 262 (block 302). The data 262 may be received from one or more mobile devices, such as one or more mobile devices 104, each of which may be associated with a respective user of the plurality of users. In one embodiment, receiving may include receiving the data 262 via an app executing on the mobile device 104. In other embodiments, the data 262 may be received from one or more merchants.

As described above, the data 262 is representative or indicative of at least partial satisfaction of the offer generation criterion by the respective user. The at least partial satisfaction of the offer generation criterion may be a greater than zero satisfaction, half satisfaction, substantial satisfaction, or a full or complete satisfaction of the offer generation criterion. The at least partial satisfaction may be from or due to a purchase, made by the respective user, of one or more products and/or services at the one or more merchants. The at least partial satisfaction may be due to a visit, by the respective user, to the one or more merchants (e.g., to a webpage and/or a store of the one or more merchants). The at least partial satisfaction may be from or due to a donation (e.g., to charity) made by the respective user.

The operation also includes determining, such as via the execution by the processor of third logic stored in the memory, by the computer, whether the data 262 has caused the user to fully satisfy the one or more offer generation criteria for that user (block 304). In some embodiments, determining may include determining whether the at least partial satisfaction represented by the data 262 itself satisfies the one or more offer generation criteria. In other embodiments, determining may include determining, based on the at least partial satisfaction represented by the data 262 and one or more previous at least partial satisfactions (e.g., purchases or transactions) represented by data stored in a database, such as a database 254, whether the at least partial satisfaction represented by the data 262 has caused the user to fully satisfy the one or more offer generation criteria for that user.

The operation further includes providing, such as via the execution by the processor of fourth logic stored in the memory, by the computer, to the mobile device 104, data 108 when the first data has caused the user to fully satisfy the offer generation criterion for that user (block 306). The data 108 representative of one or more offers for a financial incentive, such as, for example, a price discount for a future purchase, a coupon for one or more complimentary products and/or services, redeemable with the one or more merchants. The providing may include providing the data 108 when a count is equal to or greater than a threshold value or when a count is equal to zero.

The operation may also include providing, by the computer, to the mobile device 104, when the data 262 has not caused the user to fully satisfy the one or more offer generation criteria for that user, data representative of the user's progress towards fully satisfying the one or more offer generation criteria. Accordingly, the operation may further include receiving, by the computer, from the mobile device 104, additional data 262 data indicative of another at least partial satisfaction (e.g., another purchase of the product or service made) by the user, and determining, by the computer, whether the additional data 262 has caused the user to fully satisfy the offer generation criterion. When the fourth data has caused the user to fully satisfy the offer generation criterion, the operation may further include providing, by the computer, to the mobile device 104, the data 108.

The operation may also include storing, by or via the computer, the data 262 in the database 254, and/or adjusting a count of a number of purchases based on the data 262. Adjusting may include initializing the count at a zero value, incrementing the count based on the data 262, and comparing the count with a threshold value, and wherein the providing comprises providing the data 108 when the count is equal to or greater than the threshold value. Alternatively, adjusting may include initializing a count at a pre-determined non-zero value and decrementing the count based on the data 262, and wherein the providing comprises providing the data 108 when the count equals zero.

The operation may also include providing the user with data indicative of the user's progress towards fully satisfying or completing the respective one or more offer generation criteria. Providing may include, for example, providing the user with an audio or video representation, such as a virtual “punch” card, that illustrates or indicates, on, for example, a display of the mobile device 104, the user's progress towards satisfying the respective one or more offer generation criteria.

The operation may further include receiving, by the computer user data representative of at least one of the user's interests, preferences, demographics, biographical information, or combinations thereof. The operation may further include receiving, by the computer, from the merchant, data indicative of the purchase, and reconciling the data received from the merchant with the data 262 received from the mobile device 104. The operation may further include detecting fraudulent offer generation based on the reconciling.

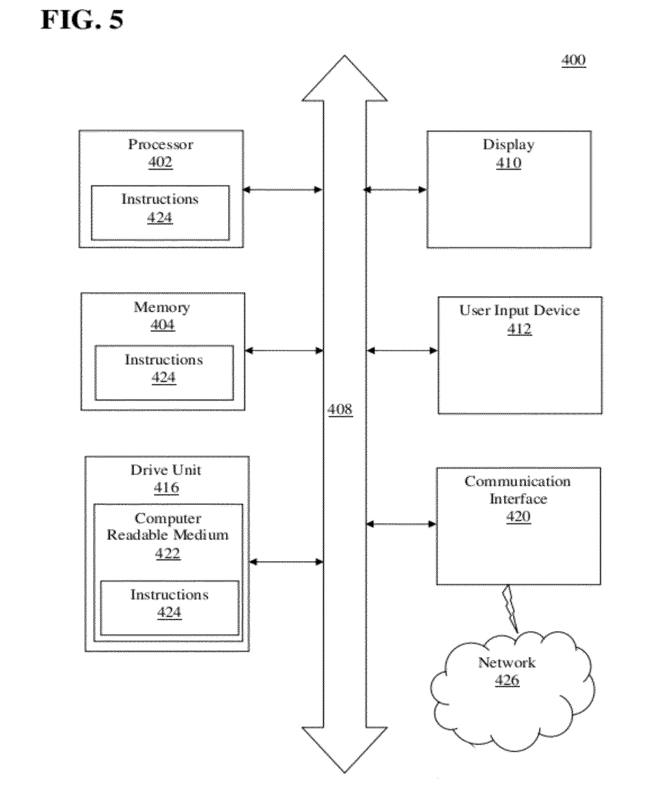

Referring to FIG. 5, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 5, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 5, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication port 918. The communication port 418 may be a part of the processor 402 or may be a separate component. The communication port 418 may be created in software or may be a physical connection in hardware. The communication port 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 900 may be physical connections or may be established wirelessly.

The network 420 may include wired networks, wireless networks, or combinations thereof, and may be representative of the network 122, 124, 126, 128 in FIG. 1. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A computer-implemented method of providing an offer for a financial incentive, the method comprising:
receiving, by the computer, an offer criterion from a merchant, the offer criterion established by the merchant for each user of a plurality of users and associated with one or more products or services offered by the merchant;
receiving, by the computer, first data indicative of at least partial satisfaction of the offer criterion by a user of the plurality of users;
determining, by the computer, whether the first data has caused the user to satisfy the offer criterion for that user; and
providing, by the computer, upon determining that the first data has caused the user to satisfy the offer criterion for that user, to a mobile device associated with the user, second data representative of an offer for a financial incentive redeemable with the merchant.

2. The computer-implemented method of claim 1, wherein the offer criterion comprises a quantity of the product or service.

3. The computer-implemented method of claim 1, wherein the offer criterion comprises a quantity of the product or service purchased during a defined time period.

4. The computer-implemented method of claim 1, wherein the offer criterion comprises a total purchase amount.

5. The computer-implemented method of claim 1, wherein the offer criterion comprises a number of rewards points.

6. The computer-implemented method of claim 1, wherein the offer criterion established for a first user of the plurality of users is different than the offer criterion established for a second user of the plurality of users.

7. The computer-implemented method of claim 1, wherein receiving an offer criterion comprises receiving offer generation criteria from the merchant, and determining comprises determining whether the first data has caused the user to satisfy one or more of the offer generation criteria for that user.

8. The computer-implemented method of claim 1, wherein the received offer generation criteria comprises a plurality of offer criterion each comprising a different number of rewards points.

9. The computer-implemented method of claim 8, further comprising providing to the user, via the mobile device, a list of the plurality of offer criterion.

10. The computer-implemented method of claim 1, wherein receiving the first data comprises receiving the first data from a mobile device associated with the user.

11. The computer-implemented method of claim 1, wherein the first data is representative of a code entered into the mobile device.

12. The computer-implemented method of claim 11, wherein the code is a machine-readable code scanned into the mobile device.

13. The computer-implemented method of claim 11, wherein the code is provided by the merchant.

14. The computer-implemented method of claim 1, wherein the at least partial satisfaction of the offer criterion is due to a purchase of a product or service by the user at the merchant.

15. The computer-implemented method of claim 1, the method further comprising storing, via the computer, the first data.

16. The computer-implemented method of claim 1, the method further comprises adjusting a count of a number of purchases based on the first data.

17. The computer-implemented method of claim 16, wherein adjusting the count comprises initializing the count at a zero value, incrementing the count based on the first data, and comparing the count with a threshold value, and wherein providing comprises providing the second data when the count is equal to or greater than the threshold value.

18. The computer-implemented method of claim 16, wherein adjusting the count comprises initializing a count at a pre-determined non-zero value and decrementing the count based on the first data, and wherein providing comprises providing the second data when the count equals zero.

19. The computer-implemented method of claim 1, wherein:
the offer criterion comprises a quantity of the product or service, and
the financial incentive comprises a price discount for a future purchase of the product or service, the price discount redeemable with the merchant.

20. The computer-implemented method of claim 1, wherein the financial incentive comprises a coupon for complimentary product or service, the coupon redeemable with the merchant.

21. The computer-implemented method of claim 1, wherein the financial incentive expires a specified time period after the providing.

22. The computer-implemented method of claim 1, wherein when the first data has not caused the user to satisfy the offer criterion for that user, the method further comprising providing, by the computer, to the mobile device associated with the user, third data representative of the user's progress towards satisfying the offer criterion.

23. The computer-implemented method of claim 22, further comprising:
receiving, by the computer, fourth data indicative of another at least partial satisfaction of the offer criterion by the user;
determining, by the computer, whether the fourth data has caused the user to fully satisfy the offer criterion; and, when the fourth data has caused the user to satisfy the offer criterion,
providing, by the computer, to the mobile device, the second data.

24. The computer-implemented method of claim 1, the method further comprising receiving, by the computer, user data representative of at least one of the user's interests, preferences, demographics, biographical information, or combinations thereof.

25. The computer-implemented method of claim 1, the method further comprising monitoring a frequency at which the first data is received.

26. The computer-implemented method of claim 1, wherein receiving the first data comprises receiving the first data from the mobile device, the method further comprising:
receiving, by the computer, from the merchant, data indicative of the purchase; and
reconciling the data received from the merchant with the first data received from the mobile device.

27. The computer-implemented method of claim 26, the method further comprising detecting fraudulent offer generation based on the reconciling.

28. The computer-implemented method of claim 1, wherein the second data comprises at least a redemption indicia operative to be presented to a merchant to obtain the financial incentive.

29. The computer-implemented method of claim 28, the method further comprising causing the mobile device to conceal the redemption indicia until the user causes the device to reveal the redemption indicia.

30. The computer-implemented method of claim 29, the method further comprising:
determining, by the computer, that the user has caused the device to reveal the redemption indicia; and
accounting, by the computer, for the redemption of the offer by the user based thereon.

31. The computer-implemented method of claim 28, wherein the redemption indicia is unique to the user.

32. The computer-implemented method of claim 28, wherein the redemption indicia comprises an alphanumeric code, a machine readable code, an image, an audible message, a signal operative to be transmitted via a radio frequency, or combination thereof.

33. The computer-implemented method of claim 29, wherein the second data further comprises a condition to be satisfied to enable the user to cause the device to reveal the redemption indicia.

34. The computer-implemented method of claim 33, wherein the condition comprises a substantial convergence between specified geographic coordinates and coordinates provided by a GPS device contained within the device.

35. The computer-implemented method of claim 33, wherein the condition comprises performance of a confirmatory action by the merchant.

36. The computer-implemented method of claim 29, the method further comprising:
prior to the determining that the user has caused the device to reveal the redemption indicia, determining that the user is attempting to cause the device to reveal the redemption indicia;
determining whether the offer associated with the redemption indicia is valid; and
enabling the device to reveal the redemption indicia if the offer associated with the redemption indicia is valid and otherwise preventing the device from revealing the redemption indicia

37. The computer-implemented method of claim 33, wherein the determining further comprises receiving a message from the device indicating that the user has at least attempted to cause the device to reveal the redemption indicia, the message having been automatically transmitted in response thereto.

38. The computer-implemented method of claim 29, the method further comprising enabling the device to reveal the redemption indicia in response to a specific user interaction with the device.

39. The computer-implemented method of claim 38, wherein the specific user interaction comprises a simulated scratching motion on an interactive display of the device.

40. The computer-implemented method of claim 30, wherein the accounting further comprises invalidating the offer for subsequent redemption.

41. The computer-implemented method of claim 30, wherein the accounting further comprises invalidating the offer for subsequent redemption.

42. The computer-implemented method of claim 30, wherein the accounting further comprises adjusting a count of the number of redemptions of the offer.

43. The computer-implemented method of claim 30, the method further comprising:
receiving data indicative of the redemption of the offer from the merchant; and
reconciling the received data with the accounted for redemption by the user.

44. The computer-implemented method of claim 43, the method further comprising detecting fraudulent redemption based on the reconciling.

45. The computer-implemented method of claim 43, the method further comprising determining marketing effectiveness of the offer based on the reconciling.

46. A system of providing an offer for a financial incentive, the system comprising:
an offer server operative to (i) receive an offer criterion from a merchant, the offer criterion established by the merchant for each user of a plurality of users and associated with a product or service offered by the merchant, (ii) receive first data indicative of at least partial satisfaction of the offer criterion by a user of the plurality of users, and (iii) determine whether the first data has caused the user to satisfy the offer criterion for that user; and
wherein, when the first data has caused the user to satisfy the offer criterion for that user, the offer server is further operative to provide to the user, via a mobile device associated with the user, second data representative of an offer for a financial incentive redeemable with the merchant.

47. The system of claim 46, wherein the offer criterion comprises a quantity of the product or service.

48. The system of claim 46, wherein the offer criterion comprises a quantity of the product or service purchased during a defined time period.

49. The system of claim 46, wherein the offer criterion comprises a total purchase amount.

50. The system of claim 46, wherein the offer criterion comprises a number of rewards points.

51. The system of claim 46, wherein the offer server is operative to receive offer generation criteria from the merchant and to determine whether the first data has caused the user to satisfy one or more of the offer generation criteria for that user.

52. The system of claim 46, wherein the received offer generation criteria comprises a plurality of offer criterion each comprising a different number of rewards points.

53. The system of claim 46, wherein the first data is indicative of a code entered into the mobile device.

54. The system of claim 53, wherein the code is a machine-readable code scanned by the mobile device.

54. The system of claim 46, the system further comprising a database, wherein the offer server is further operative to store the first data in the database.

55. The system of claim 46, wherein the offer server is further operative to adjust, based on the first data, a count of a number of purchases for the user.

56. The system of claim 55, wherein the count is initially set at zero, and wherein the offer server is further operative to increment the count based on the first data, compare the count with a threshold value, and provide the second data when the count is equal to or greater than the threshold value.

57. The system of claim 55, wherein the count is initially set at a pre-determined non-zero value, and wherein the offer server is further operative to decrement the counter based on the first data and provide the second data when the count equals zero.

58. The system of claim 46, wherein the offer criterion comprises a quantity of the product or service, and the financial incentive comprises a price discount for a future purchase of the product or service, the price discount redeemable with the merchant.

59. The system of claim 46, wherein the financial incentive comprises a coupon for a complimentary product or service, the coupon redeemable with the merchant.

60. The system of claim 46, wherein the second data comprises at least a redemption indicia operative to be presented to a merchant to obtain the financial incentive.

61. The system of claim 46, wherein when the first data has not caused the user to satisfy the offer criterion for that user, the offer server is further operative to provide to the mobile device third data representative of the user's progress towards satisfying the offer criterion.

62. The system of claim 61, wherein the offer server is further operative to:
receive, fourth data indicative of another at least partial satisfaction of the offer criterion by the user;
determine whether the fourth data has caused the user to satisfy the offer criterion for that user; and
provide, to the mobile device, the second data upon determining that the fourth data has caused the user to satisfy the offer criterion for that user.

63. The system of claim 46, wherein the offer server is operative to communicate with the mobile device via a wireless network.

64. The system of claim 46, wherein the offer server is operative to receive the first data from the mobile device via an application executing on the mobile device and to provide the second data to the mobile device via the application executing on the mobile device.

65. The system of claim 46, wherein the financial incentive expires a specified time period after the providing.

66. A system for providing an offer for a financial incentive, the system comprising a processor and a memory coupled therewith, the system further comprising:
first logic stored in the memory and executable by the processor to cause the processor to receive an offer criterion associated with a product or service offered by a merchant, the offer criterion established by the merchant for each user of a plurality of users;
second logic stored in the memory and executable by the processor to cause the processor to receive, from a mobile device associated with a user of the plurality of users, first data indicative of at least partial satisfaction of the offer criterion by the user;
third logic, coupled with the first logic and the second logic, stored in the memory and executable by the processor to cause the processor to determine whether the first data has caused the user to satisfy the offer criterion; and
fourth logic, coupled with the third logic, stored in the memory and executable to cause the processor to provide to the mobile device second data representative of an offer for a financial incentive redeemable with the merchant when the first data has caused the user to fully satisfy the offer criterion.
